(19) United States
(12) Patent Application Publication
(10) Pub. No.: US 2014/0014597 A1
(43) Pub. Date: Jan. 16, 2014

(54) Dual Flow Filter Element

(71) Applicant: CUMMINS FILTRATION IP, INC., Columbus, IN (US)

(72) Inventors: Jessie A. Knight, Madison, WI (US); Kenneth M. Tofsland, Stoughton, WI (US); Mark A. Terres, Shakopee, MN (US); Scott W. Schwartz, Cottage Grove, WI (US); Thomas J. Braun, Stoughton, WI (US); Andrea L. Kendall, Cambridge, WI (US)

(73) Assignee: Cummins Filtration IP, Inc., Columbus, IN (US)

(21) Appl. No.: 13/771,357

(22) Filed: Feb. 20, 2013

Related U.S. Application Data
(60) Provisional application No. 61/671,613, filed on Jul. 13, 2012.

(51) Int. Cl. B01D 29/50

(52) U.S. Cl. CPC B01D 29/50
USPC 210/806; 210/315

(57) ABSTRACT

A dual flow filter element includes inner and outer closed loop filter media and inlet and outlet end caps, and having a given shape-in-shape configuration. A support frame extends axially from one of the end caps toward the other end cap and terminates at a termination position between one-fourth and three-fourths of the axial distance between the inlet and outlet ends. Combinations using pleated filter media include a first group of pleat tip ends which are exposed, and a second group of pleat tip ends which are fully potted. One embodiment includes axially offset inner and outer closed loop filter media.

### CROSS-REFERENCE TO RELATED APPLICATION

This application claims the benefit of and priority from Provisional U.S. Patent Application No. 61/671,613, filed Jul. 13, 2012, hereby incorporated herein by reference.

### BACKGROUND AND SUMMARY

Dual flow filters are known in the prior art, including filter elements having an inner closed loop filter media positioned radially within an outer closed loop filter media, wherein the inner filter media and the outer filter media are spaced apart at one of an inlet end and an outlet end, and are substantially adjacent at the other of the inlet end and the outlet end, thus defining a V-shaped configuration in cross-section.

The present disclosure arose during continuing development efforts in the above technology.

### BRIEF DESCRIPTION OF THE DRAWINGS

FIG. 1 is a perspective view of a filter element in accordance with the present disclosure.

FIG. 2 is a perspective cut-away sectional view of the filter element of FIG. 1.

FIG. 3 is a perspective view from above of the filter element of FIG. 1, showing the inlet end.

FIG. 4 is a perspective view from below of the filter element of FIG. 1, showing the outlet end.

FIG. 5 is a perspective view of the inlet end cap of FIG. 1.

FIG. 6 is a perspective view of the underside of the inlet end cap of FIG. 5.

FIG. 7 is a perspective view of the outlet end cap of FIG. 1.

FIG. 8 is an inverted exploded perspective view of the assembly of FIG. 1.

FIG. 9 is an enlarged sectional view of a portion of FIG. 2.

FIG. 10 is a top view of the filter element of FIG. 1.

FIG. 11 is a side view of the filter element of FIG. 1.

FIG. 12 is another side view of the filter element of FIG. 1.

FIG. 13 is a perspective view of another embodiment of the filter element of FIG. 1.

FIG. 14 is a sectional view taken along line 14-14 of FIG. 13.

FIG. 15 is a sectional view taken along line 15-15 of FIG. 13.

FIG. 16 is a sectional view showing another embodiment of the filter element of FIG. 1.

FIG. 17 is like FIG. 16 and shows another embodiment.

FIG. 18 is like FIG. 16 and shows another embodiment.

FIG. 19 is a perspective view showing another embodiment of a filter element in accordance with the present disclosure.

FIG. 20 is a sectional view taken along line 20-20 of FIG. 19.

FIG. 21 is an exploded perspective view of the filter element of FIG. 19.

FIG. 22 is like FIG. 19 and shows another embodiment.

FIG. 23 is a perspective view of the filter element of FIG. 22.

### DETAILED DESCRIPTION

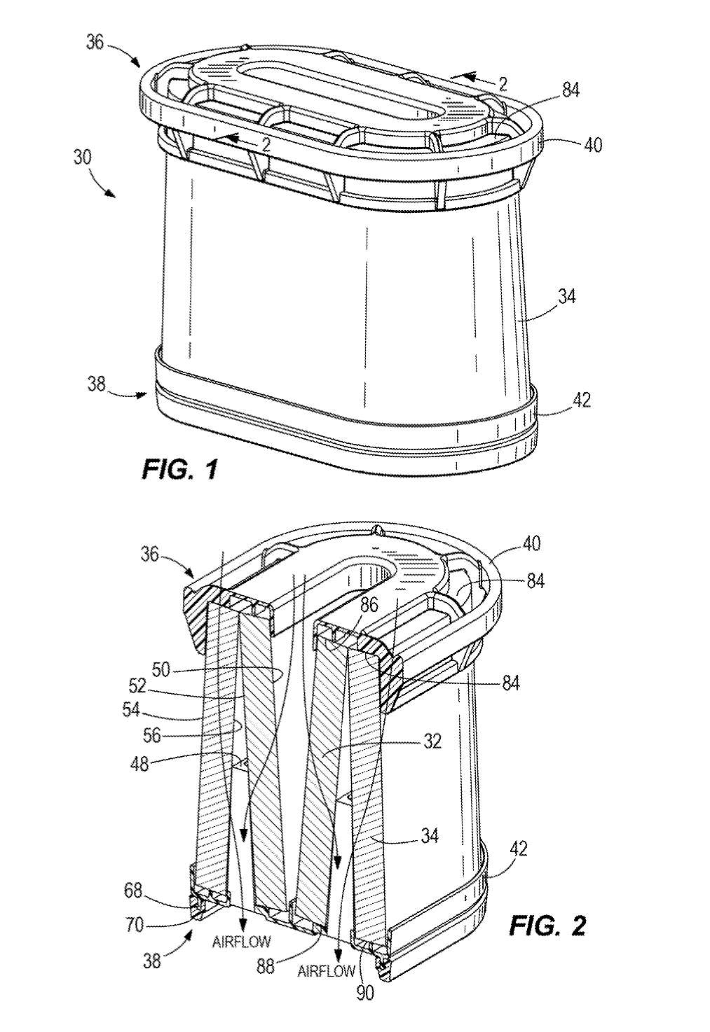

FIG. 1 shows a filter element 30 having an inner closed loop filter media 32, FIG. 2, positioned radially within an outer closed loop filter media 34. Inner filter media 32 and outer filter media 34 are spaced apart at one of an inlet end 36 and an outlet end 38, for example at outlet end 38, and are substantially adjacent to each other at the other of the inlet end and the outlet end, for example at inlet end 36. The closed loop filter media may have various shapes. In one embodiment, each of the inner and outer closed loop filter media is a racetrack, providing a racetrack-in-racetrack configuration. In another embodiment, each of the inner and outer closed loop filter media is an oval, providing an oval-in-oval configuration. In another embodiment, each of the inner and outer closed loop filter media is a cone, providing a cone-in-cone configuration. In one embodiment, at least one of the noted cones is a frusta-cone. In one embodiment, the inner closed loop filter media and the outer closed loop filter media are coaxial along an axis, and the inner closed loop filter media narrowingly tapers along a first axial direction and defines a first V-shaped cross-section pointing in the first axial direction, and the outer closed loop filter media narrowingly tapers along a second axial direction, opposite to the first axial direction, and defines a second V-shaped cross-section pointing in the second axial direction, whereby the inner and outer closed loop filter media narrowingly taper in opposite axial directions, and the first and second V-shaped cross-sections point oppositely to each other.

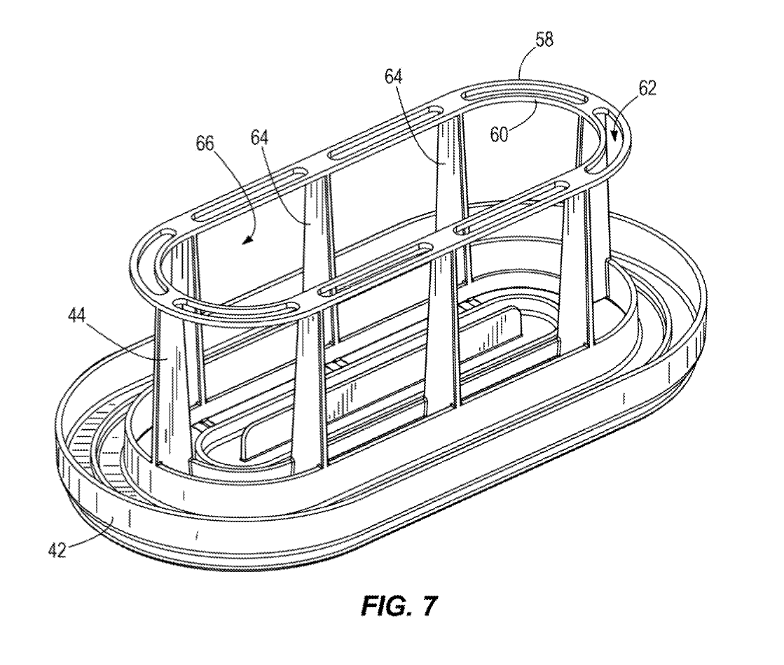

An inlet end cap 40 is attached to the inner filter media and the outer filter media at the inlet end 36. An outlet end cap 42 is attached to the inner filter media and the outer filter media at the outlet end 38. One of the end caps, for example end cap 38, has a support frame 44, FIG. 7, extending axially therefrom towards the other end cap and terminating at a termination end 46 at a termination position 48. FIG. 2, between one-fourth and three-fourths of the axial distance between inlet end 36 and outlet end 38.

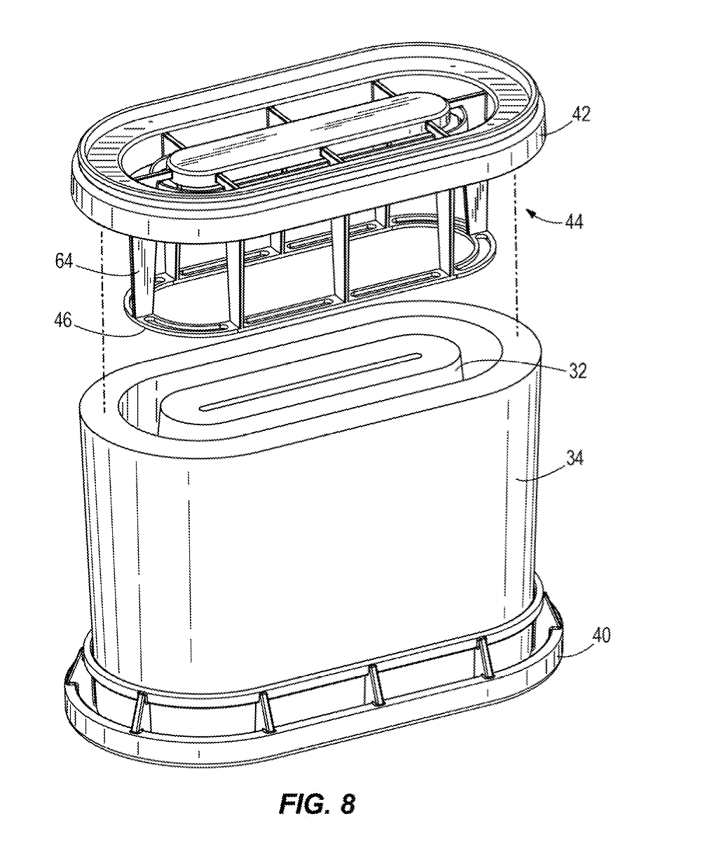

Fluid to be filtered, e.g. air, gas, liquid, or other fluid, flows through inner filter media 32 from a first upstream side 50 to a first downstream side 52, and flows through outer filter media 34 from a second upstream side 54 to a second downstream side 56. Support frame 44, FIGS. 7, 8, extends axially along at least one of the first and second downstream sides 52 and 56 and provides support against differential-pressure-induced radial movement of the respective filter media. In FIGS. 2, 4, 8, support frame 44 extends axially along both of the first and second downstream sides 52 and 56. In one embodiment, the support frame extends axially along and engages each of first and second downstream sides 52 and 56. In the embodiment of FIGS. 2, 4, 7, 8, support frame 44 is located radially between first and second downstream sides 52 and 56. In one embodiment, the noted termination position 48 is between 40% to 60% of the axial distance between inlet end 36 and outlet end 38. In a further embodiment, termination position 48 is about 50% of the axial distance between inlet end 36 and outlet end 38.

The direction of flow may be reversed from that shown in FIG. 2, with end 38 being the inlet end, and end 36 being the outlet end, with filter media sides 52 and 56 being upstream sides, and filter media sides 50 and 54 being downstream sides, and with the support frame extending from a designated end cap along at least one of the downstream sides

Support frame 44. FIG. 7, at its termination end 46 at the noted termination position 48, includes at least two radially spaced apart tracks 58 and 60 that define a plurality of vent holes or slots 62 providing flow passages. Support frame 44 also includes a plurality of ribs or columns 64 extending axially between end cap 42 and termination end 46 and defining a plurality of flow passages 66 therebetween.

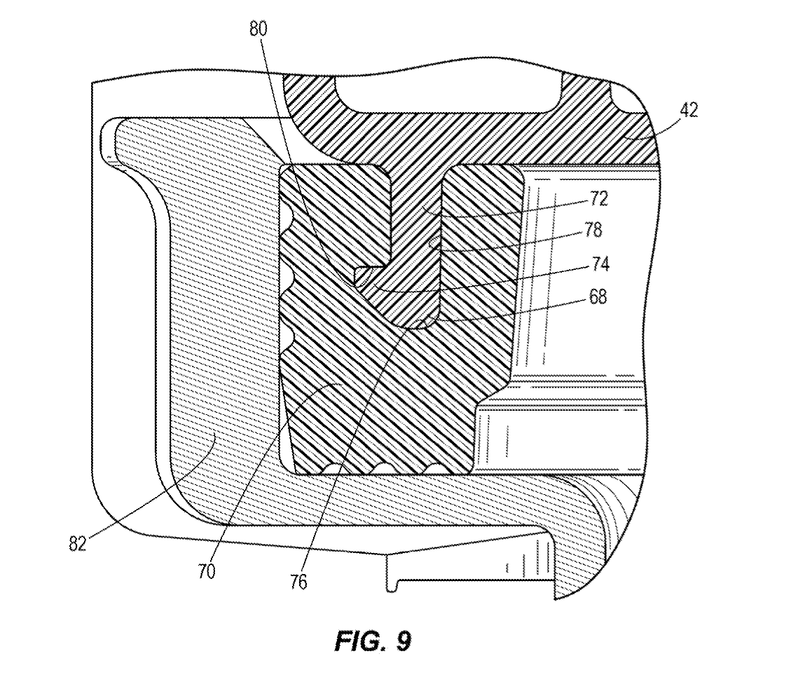

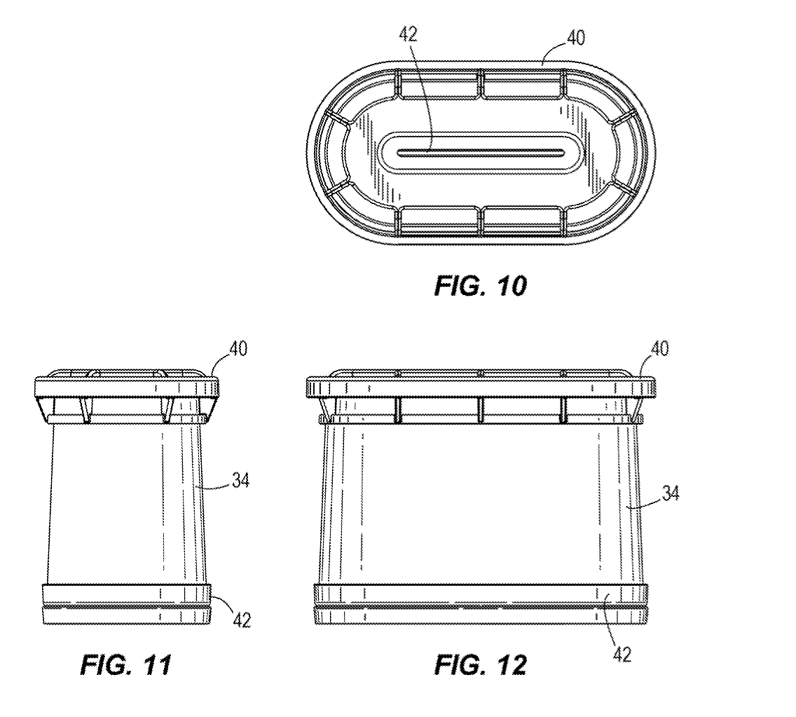

One of the end caps, e.g. end cap 42, includes a protruding barb 68, FIGS. 2, 9. A sealing gasket 70 is connected to the end cap by barb 68. In one embodiment, the barb is an L-shaped member having an axially extending first leg 72, and a radially extending second leg 74. Sealing gasket 70 has an L-shaped pocket 76, with an axially extending first cavity 78 receiving leg 72, and a radially extending second cavity 80 receiving second leg 74. The gasket is provided for sealing the filter element in a housing such as 82.

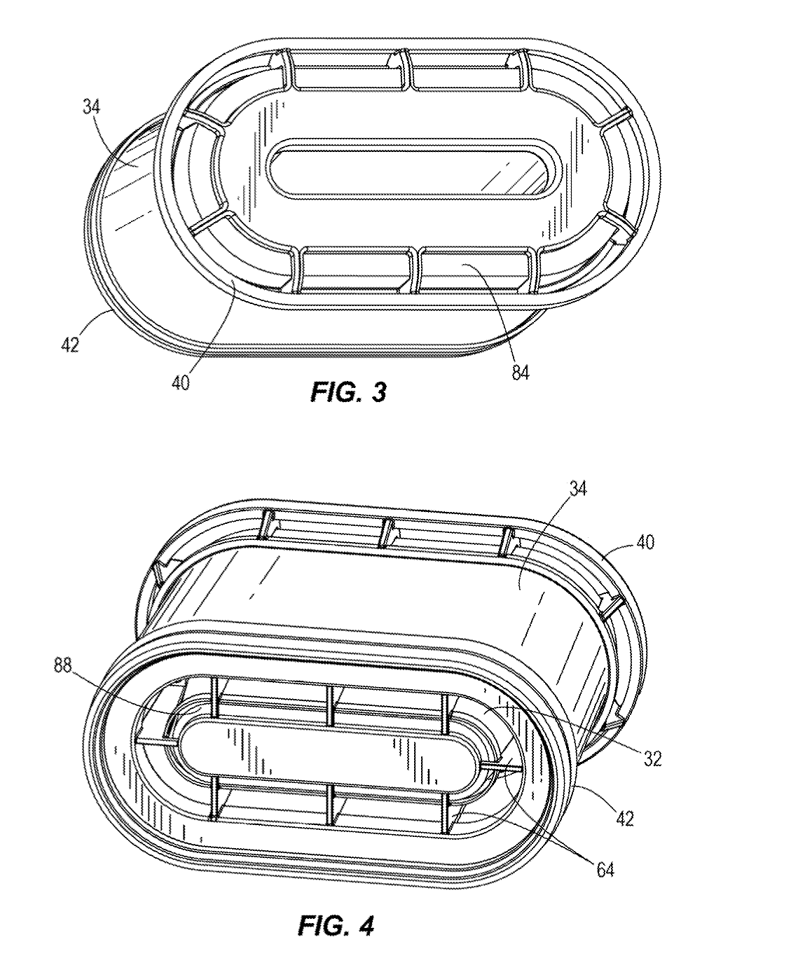

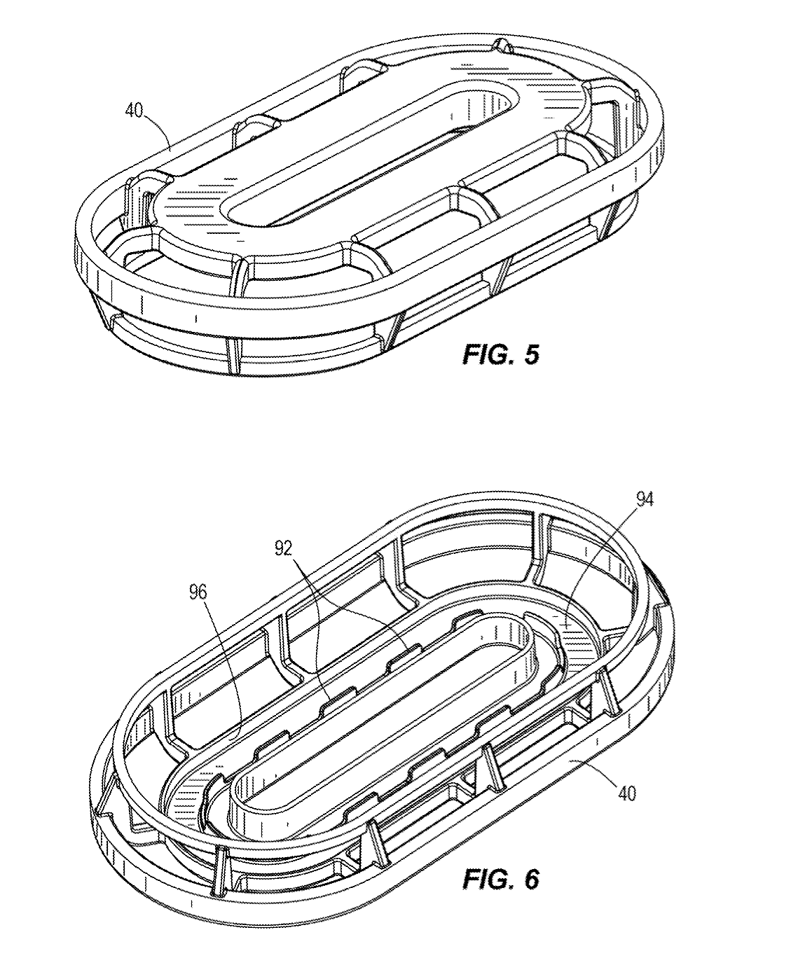

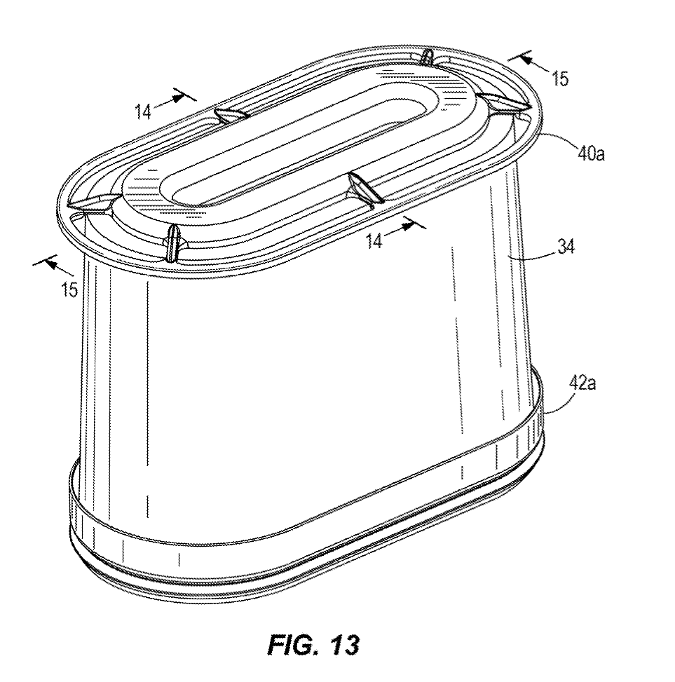

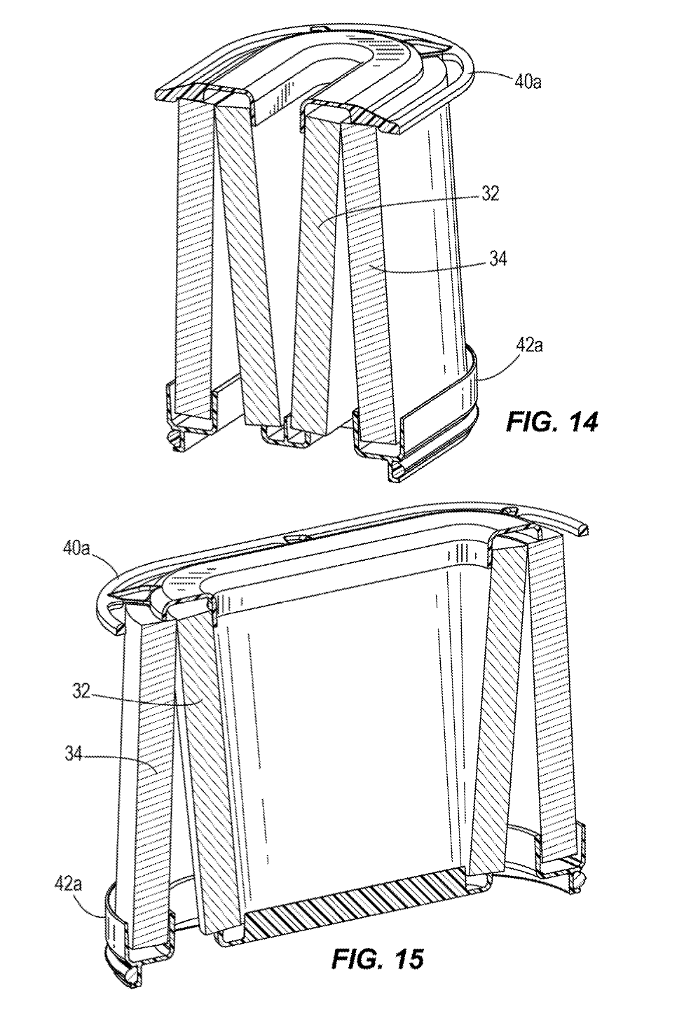

In one embodiment, the filter element includes radially nested inner and outer closed loop pleated filter media configured to define a V-shaped cross-section, FIG. 2. An inlet end cap such as 40 is attached to the inlet end 36 of each of the inner and outer closed loop pleated filter media 32 and 34. An outlet end cap such as 42 is attached to the outlet end 38 of each of the inner and outer closed loop pleated filter media 32 and 34. As in U.S. Pat. No. 6,511,599, and U.S. Pat. No. 7,323,106, both incorporated herein by reference, each of the closed loop pleated filter media members may have a plurality of pleats defined by wall segments extending radially in serpentine manner between inner and outer sets of pleat tips at inner and outer sets of axially extending bend lines having pleat tip ends at ends 36 and 38, wherein the wall segments extend axially between upstream and downstream ends at 36 and 38, with the wall segments defining axial flow channels therebetween, with the upstream ends of the wall segments being alternately sealed to each other, if exposed, to define a first set of flow channels having open upstream ends, and a second set of flow channels interdigitated with the first set of flow channels and having closed upstream ends, and the downstream ends of the wall segments, if exposed being, alternately sealed to each other such that the first set of flow channels have closed downstream ends, and the second set of flow channels have open downstream ends, or alternatively the noted alternate sealing may be omitted if there is full potting of the axial ends of the pleats including pleat tip ends. In the present disclosure, various combinations, to be described, include a first group of pleat tip ends such as 84, FIGS. 1-3, which are exposed, and a second group of pleat tip ends such as 86 which are fully potted. In a further embodiment, a first group of pleat tip ends 88 is exposed, and a second group of pleat tip ends 90 is fully potted. The exposed pleat tip ends provide axial flow-through therethrough, for which further reference may be had to the noted incorporated '599 and '106 patents. In one embodiment, inner pleated filter media 32 is only partially potted at one of the inlet end 36 and the outlet end 38, for example at outlet end 38, leaving exposed pleat tip ends at 88, and is fully potted at the other of the inlet end and the outlet end, for example at inlet end 36 at fully potted pleat tips ends 86. In a further embodiment, the outer pleated filter media 34 is fully potted at one of the inlet end 36 and the outlet end 38, for example at outlet end 38 at fully potted pleat tip ends 90, and is only partially potted at the other of the inlet end and the outlet end, for example at inlet end 36 leaving pleat up ends exposed at 84. In a further implementation, both of the noted embodiments are combined, such that inner pleated filter media 32 is only partially potted at one of the inlet end and the outlet end, for example at outlet end 38 leaving exposed pleat tip ends at 88, and is fully potted at the other of the inlet end and the outlet end, for example at inlet end 16 at fully potted pleat tip ends 86, and the outer pleated filter media is fully potted at the noted one of the inlet end and the outlet end, for example at outlet end 38 at fully potted pleat tip ends 90, and is only partially potted at the noted other of the inlet end and the outlet end, for example inlet end 36 leaving exposed pleat tip ends at 84. FIGS. 13-15 show alternate end cap versions at 40a and 42a, and otherwise use like reference numerals from above where appropriate to facilitate understanding.

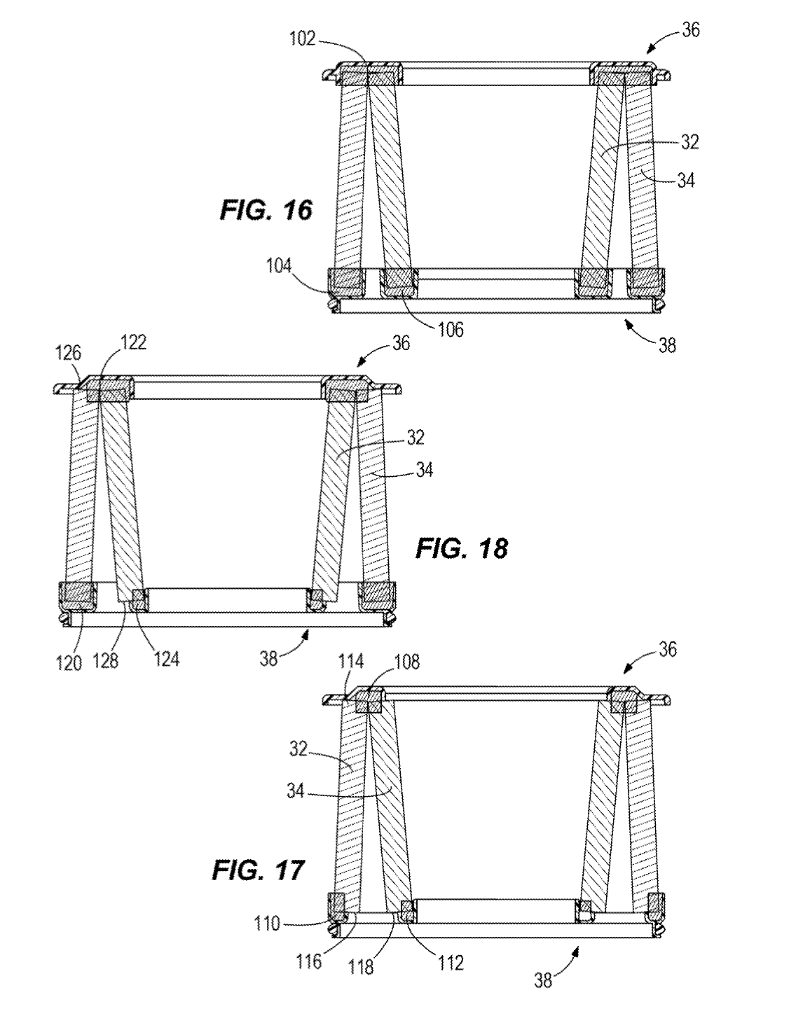

FIGS. 16-18 show further embodiments with various full and partial potting combinations and exposed pleat tip ends. In FIG. 16, full potting is shown at 102, 104, 106. In FIG. 17, partial potting is shown 108, 110, 112, and exposed pleat tip ends are shown at 114, 116, 118. In FIG. 18, full potting is shown at 120, partial potting is shown at 122, 124, and exposed pleat tip ends are shown 126, 128.

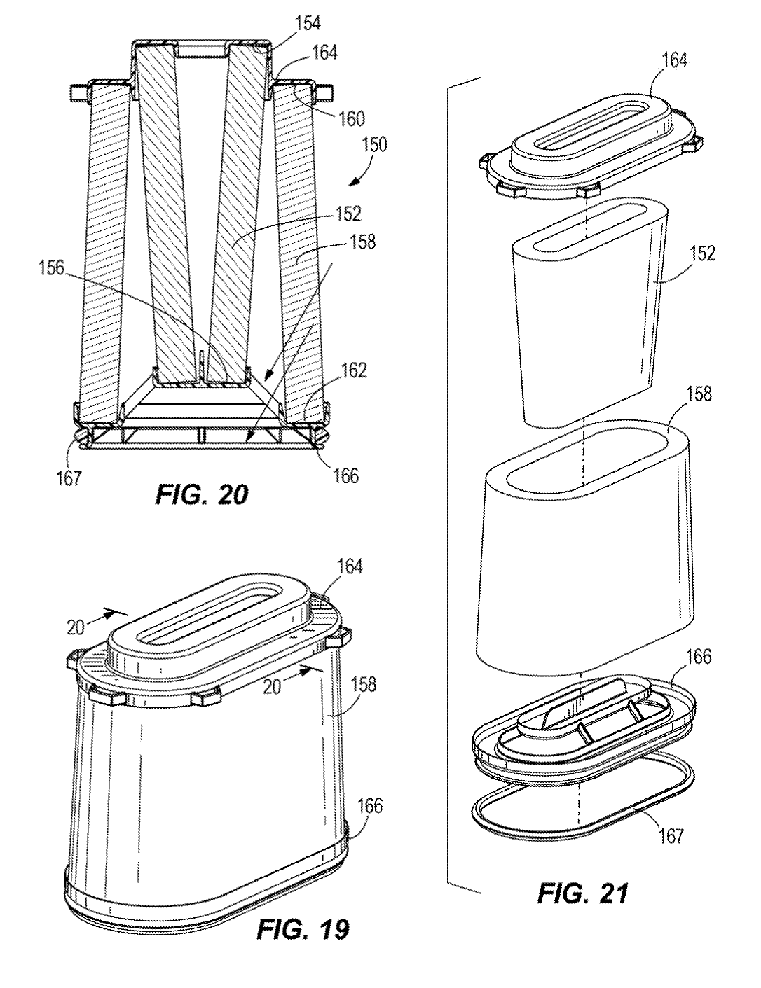

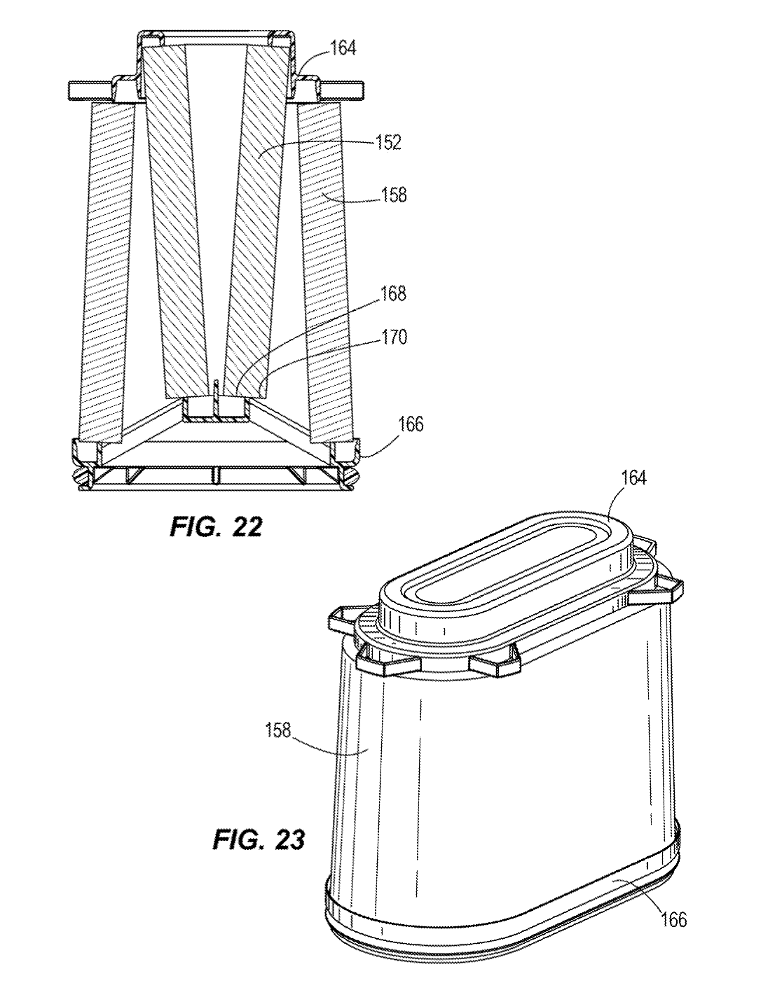

In a further embodiment, FIGS. 19-23, filter element 150 includes an inner closed loop filter media 152 extending axially between first and second axial ends 154 and 156 and radially nested in an outer dosed loop filter media 158 extending, axially between third and fourth axial ends 160 and 162. First axial end 154 extends axially beyond third axial end 160. In one embodiment in combination the fourth axial end 162 extends axially beyond second axial end 156, whereby inner and outer closed loop filter media 152 and 158 are axially offset from each other at each of a) first and third axial ends 154 and 160; and b) second and fourth axial ends 156 and 162. In this embodiment, first axial end 154 extends axially beyond third axial end 160 in a direction away from outer closed loop filter media 158, and fourth axial end 162 extends axially beyond second axial end 156 in a direction away from inner closed loop filter media 152. This reduces flow resistance and restriction by creating a larger flow area, including inlet and outlet areas for flow, while also maximizing space-usage. The inner and outer closed loop filter media may be fully potted at each of endcaps 164 and 166, which in one embodiment are inlet and outlet endcaps, respectively, though the flow may be reversed. One or both of the endcaps may include a gasket, for example gasket 167. In a further embodiment, where the inner and outer closed loop filter media are pleated and have pleat tip ends at the axial ends, the axial ends may be fully potted, FIG. 20, or alternatively the pleat tip end may be partially potted and partially exposed, for example as shown respectively at 168 and 170 in FIG. 22.

The disclosure provides a method of reducing flow resistance and restriction, including providing a filter element, including providing an inner closed loop filter media positioned radially within an outer closed loop filter media, spacing the inner filter media and the outer filter media apart at one of the inlet end and the outlet end, and positioning the inner filter media and the outer filter media substantially adjacent at the other of the inlet end and the outlet end. The method includes providing the inner closed loop filter media and the outer closed loop filter media coaxial along an axis, narrowingly tapering the inner closed loop filter media along a first axial direction and defining a first V-shaped cross-section pointing in the first axial direction, and narrowingly tapering the outer closed loop filter media along a second axial direction, opposite to the first axial direction, and defining a second V-shaped cross-section pointing in the second axial direction, whereby to narrowingly taper the inner and outer closed loop filter media in opposite axial directions, with the first and second V-shaped cross-sections pointing oppositely to each other.

The disclosure provides a method for preventing collapse of a dual flow filter element by axially extending a support frame 11 from one of the ends caps such as 42 towards the other of the end caps such as 40, and terminating the support frame at a termination end 46 at a termination position 48 between one-fourth and three-fourths of the axial distance between the inlet end 36 and the outlet end 38.

The disclosure provides a method for assembling a dual flow pleated filter element including exposing a first group of pleat tip ends of pleated filter media and fully potting a second group of pleat tip ends of pleated filter media. At least one of the end caps, such as inlet end cap 40, may be provided with a plurality of axial projections 92, FIG. 6, that trace a staggered circumferential loop around a portion of the end cap and space the pleat tip ends from the fining end surface 94 of the end cap to assure flow of potting material therearound. Sidewall portion 96 of the end cap provides a dam blocking flow of potting material radially therebeyond, to thus provide exposed pleat tip ends as at 84.

The disclosure provides a method of reducing flow resistance and restriction including providing a filter element including providing an inner closed loop filter media extending axially between first and second axial ends and radially nested in an outer closed loop filter media extending axially between third and fourth axial ends, and including extending the first axial end axially beyond the third axial end. The method further includes in combination extending the fourth axial end axially beyond the second axial end, whereby to axially offset the inner and outer closed loop filter media from each other at each of a) the first and third axial ends; and b) the second and fourth axial ends. The method further includes in one embodiment extending the first axial end axially beyond the third axial end in a direction away from the outer closed loop filter media, and extending the fourth axial end axially away from the second axial end in a direction away from the inner closed loop filter media.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

What is claimed is:

1. A filter element comprising an inner dosed loop filter media positioned radially within an outer closed loop filter media, wherein the inner filter media and the outer filter media are spaced apart at one of an inlet end and an outlet end and are substantially adjacent at the other of the inlet end and the outlet end.

2. The filter element according to claim wherein each of the inner and outer closed loop filter media is a racetrack, providing a racetrack-in-racetrack configuration.

3. The filter element according to claim 1 wherein each of the inner and outer closer loop filter media is an oval, providing an oval-in-oval configuration.

4. The filter element according, to claim 1 wherein each of the inner and outer closed loop filter media is a cone, providing a cone-in-cone configuration.

5. The filter element according to claim 4 wherein at least one of said cones is a frusto-cone.

6. The filter element according to claim 1 wherein said inner closed loop filter media and said outer closed loop filter media are coaxial along an axis, said inner closed loop filter media narrowingly tapers along a first axial direction and defines a first V-shaped cross-section pointing in said first axial direction, said outer closed loop filter media narrowingly tapers along a second axial direction, opposite to said first axial direction, and defines a second V-shaped cross-section pointing in said second axial direction, whereby said inner and outer closed loop filter media narrowing taper in opposite axial directions, and said first and second V-shaped cross-sections point oppositely to each other.

7. A filter element comprising:
an inner closed loop filter media positioned radially within an outer closed loop filter media, wherein the inner filter media and the outer filter media are spaced apart at one of an inlet end and an outlet end and are substantially adjacent at the other of the inlet end and the outlet end;
an inlet end cap attached to the inner filter media and the outer filter media at the inlet end;
an outlet end cap attached to the inner filter media and the outer filter media at the outlet end;
a support frame extending axially from one of said end caps toward the other of said end caps and terminating at a termination position between one-fourth and three-fourths of an axial distance between the inlet end and the outlet end.

8. The filter element according to claim 7 wherein fluid to be filtered flows through said inner filter media from a first upstream side to a first downstream side, and flows through said outer filter media from a second upstream side to a second downstream side, and said support frame extends axially along at least one of said first and second downstream sides and provides support against differential-pressure-induced radial movement of the respective said filter media.

9. The filter element according to claim 8 wherein said support flame extends axially along both of said first and second downstream sides.

10. The filter element according to claim 9 wherein said support frame extends axially along and engages each of said first and second downstream sides.

11. The filter element according to claim 8 wherein said support frame is located radially between said first and second downstream sides.

12. The filter element according to claim 7 wherein said termination position is between 40% to 60% of said axial distance between said inlet end and said outlet end.

13. The filter element according to claim 7 wherein said termination position is about 50% of said axial distance between said inlet end and said outlet end.

14. The filter element according to claim 7 wherein said support frame at said termination position includes at least two radially spaced apart tracks that define a plurality of vent holes providing flow passages.

15. The filter element according to claim 7 wherein one of said end caps includes a protruding barb, and comprising a sealing gasket connected to said one end cap by said barb.

16. The filter element according to claim 15 wherein said barb is an L-shaped member having an axially extending first leg, and a radially extending second leg, and said sealing gasket has an L-shaped pocket with an axially extending first cavity receiving said first leg, and a radially extending second cavity receiving said second leg.

17. A filter element comprising:
radially nested inner and outer closed loop pleated filter media configured to define a V-shaped cross-section;
an inlet end cap attached to an inlet end of each of the inner and outer closed loop pleated filter media;
an outlet end cap attached to an outlet end of each of the inner and outer closed loop pleated filter media;
wherein a first group of pleat tip ends of said pleated filter media is exposed, and
a second group of pleat tip ends of said pleated filter media is fully potted.

18. The filter element according to claim 17 wherein said inner pleated filter media is only partially potted at one of said inlet end and said outlet end, and is fully potted at the other of said inlet end and said outlet end.

19. The filter element according to claim 17 wherein said outer pleated filter media is fully potted at one of said inlet end and said outlet end, and is only partially potted at the other of said inlet end and said outlet end.

20. The filter element according to claim 17 wherein:
said inner pleated filter media is only partially potted at one of said inlet end and said outlet end, and is fully potted at the other of said inlet end and said outlet end;
said outer pleat tip filter media is fully potted at said one of said inlet end and said outlet end, and is only partially potted at said other of said inlet end and said outlet end.

21. The filter element according to claim 17 wherein a plurality of pleat tip ends of one of said inner and outer pleated filter media are exposed at one of said inlet end and said outlet end, and are fully potted at the other of said inlet end and said outlet end, and wherein a plurality of pleat tip ends of the other of said inner and outer pleated filter media are fully potted at said one of said inlet end and said outlet end, and are exposed at said other of said inlet end and said outlet end.

22. The filter element comprising an inner closed loop filter media extending axially between first and second axial ends and radially nested in an outer closed loop filter media extending axially between third and fourth axial ends, wherein said first axial end extends axially beyond said third axial end.

23. The filter element according to claim 22 wherein in combination said fourth axial end extends axially beyond said second axial end, whereby said inner and outer closed loop lifter media are axially offset from each other at each of: a) said first and third axial ends; and b) said second and fourth axial ends.

24. The filter element according to claim 23 wherein said first axial end extends axially beyond said third axial end in a direction away from said outer closed loop filter media, and wherein said fourth axial end extends axially beyond said second axial end in a direction away from said inner closed loop filter media.

25. The filter element according to claim 22 wherein said inner closed loop filter media and said outer closed loop filter media are coaxial along an axis, said inner closed loop filter media narrowingly tapers along a first axial direction and defines a first V-shaped cross-section pointing in said first axial direction, said outer closed loop filter media narrowingly tapers along a second axial direction, opposite to said first axial direction, and defines a second V-shaped cross-section pointing in said second axial direction, whereby said inner and outer closed loop filter media narrowingly taper in opposite axial directions, and said first and second V-shaped cross-sections point oppositely to each other.

26. The filter element according to claim 22 wherein said inner and outer closed loop filter media are pleated and have pleat tip ends at said axial ends, and wherein at least a portion of said pleat tip ends is potted.

27. The filter according to claim 26 wherein said pleat tip ends are fully potted.

28. The filter element according to claim 26 wherein said pleat tip ends are partially exposed and partially potted.

29. A method of reducing flow resistance and restriction in a filter element comprising providing an inner closed loop filter media positioned radially within an outer closed loop filter media, spacing said inner filter media and said outer filter media apart at one of an inlet end and an outlet end, and positioning said inner filter media and said outer filter media substantially adjacent at the other of said inlet end and said outlet end.

30. The method according to claim 29 comprising providing said inner dosed loop filter media and said outer closed loop filter media coaxial along an axis, narrowingly tapering said inner closed loop filter media along a first axial direction and defining a first V-shaped cross-section pointing in said first axial direction, narrowingly tapering said outer closed loop filter media along a second axial direction, opposite to said first axial direction, and defining a second V-shaped cross-section pointing in said second axial direction, whereby to narrowingly taper said inner and outer closed loop filter media in opposite axial directions, with said first and second V-shaped cross-sections pointing oppositely to each other.

31. A method for preventing collapse of a dual flow filter element having a parallel flow through radially nested inner and outer closed loop filter media configured to define a V-shaped cross-section, including an inner closed loop filter media positioned radially within an outer closed loop filter media, wherein the inner filter media and the outer filter media are spaced apart at one of an inlet end and an outlet end and are substantially adjacent at the other of the inlet end and the outlet end, and including an inlet end cap attached to the inner filter media and the outer filter media at the inlet end, and an outlet end cap attached to the inner filter media and the other filter media at the outlet end, comprising providing a support frame extending axially from one of said end caps toward the other of said end caps, terminating said support frame at a termination position between one-fourth and three-fourths of an axial distance between the inlet end and the outlet end.

32. The method according to claim 31 comprising flowing fluid to be filtered through said inner filter media from a first upstream side to a first downstream side, flowing said fluid through said outer filter media from a second upstream side to a second downstream side, extending said support frame axially along at least one of said first and second downstream sides and providing support against differential-pressure-induced radial collapse movement of the respective said filter media.

33. The method according to claim 32 comprising extending said support frame axially along both of said first and second downstream sides.

34. The method according to claim 33 comprising extending said support frame axially along and engaging each of said first and second downstream sides.

35. The method according to claim 32 comprising locating said support frame radially between said first and second downstream sides.

36. A method for assembling a dual flow pleated media filter element comprising providing radially nested inner and outer closed loop pleated filter media configured to define a V-shaped cross-section, providing an inlet end cap attached to an inlet end of each of the inner and outer closed loop pleated filter media, providing an outlet end cap attached to an outlet end of each of the inner and outer closed loop pleated filter media, exposing a first group of pleat tip ends of said pleated filter media, and fully potting a second group of pleat tip ends of said pleated filter media.

37. The method according to claim 36 comprising, only partially potting said inner pleated filter media at one of said inlet end and said outlet end, and fully potting said inner pleated filter media at the other of said inlet end and said outlet end.

38. The method according to claim 36 comprising fully potting said outer pleated filter media at one of said inlet end and said outlet end, and only partially potting said outer pleated filter media at the other of said inlet end and said outlet end.

39. The method according to claim 36 comprising only partially potting said inner pleated filter media at one of said inlet end and said outlet end, filly potting said inner pleated filter media at the other of said inlet end and said outlet end, fully potting said outer pleated filter media at said one of said inlet end and said outlet end, and only partially potting said outer pleated filter media at said other of said inlet end and said outlet end.

40. The method according to claim 36 comprising exposing a plurality of pleat tips of one of said inner and outer pleated filter media at one of said inlet end and said outlet end, fully potting said plurality of pleat tips of said one of said inner and outer pleated filter media at the other of said inlet end and said outlet end, fully potting a plurality of pleat tips of said other of said inner and outer pleated filter media at said One of said inlet end and said outlet end, and exposing said plurality of pleat tips of said other of said inner and outer pleated filter media at said other of said inlet end and said outlet end.

41. The method according to claim 36 comprising providing at least one of said end caps with a plurality of axial projections that trace a staggered circumferential loop around a portion of the respective end cap and space pleat tip ends of the respective pleated filter media from an end cap surface to assure flow of potting material therearound.

42. The method according to claim 36 comprising providing one of said end caps with a sidewall portion providing a dam blocking flow of potting material radially therebeyond, to provide exposed pleat tip ends.

43. A method of reducing flow resistance and restriction in a filter element comprising providing an inner closed loop filter media extending axially between first and second axial ends and radially nested in an outer closed loop filter media extending axially between third and fourth axial ends, and comprising extending said first axial end axially beyond said third axial end.

44. The method according to claim 43 comprising in combination extending said fourth axial end axially beyond said second axial end, whereby to axially offset said inner and outer closed loop filter media from each other at each of a) first and third axial ends; and b) said second and fourth axial ends.

45. The method according to claim 44 comprising extending said first axial end axially beyond said third axial end in a direction away from said outer closed loop filter media, and extending said fourth axial end axially beyond said second axial end in a direction away from said inner closed loop filter media.

46. The method according to claim 43 wherein said inner closed loop filter media and said outer closed loop filter media are coaxial along an axis, said inner closed loop filter media narrowingly tapers along a first axial direction and defines a first V-shaped cross-section pointing in said first axial direction, said outer closed loop filter media narrowingly tapers along a second axial direction, opposite to said first axial direction, and defines a second V-shaped cross-section pointing in said second axial direction, whereby said inner and outer closed loop filter media narrowingly taper in opposite axial directions, and said first and second V-shaped cross-sections point oppositely to each other.
